(19) United States
(12) Patent Application Publication
(10) Pub. No.: US 2008/0169178 A1
(43) Pub. Date: Jul. 17, 2008

(54) Tap Changer

(76) Inventors: Reinhold Baertl, Lappersdorf (DE); Albert Schmidbauer, Roding (DE)

Correspondence Address: K.F. ROSS P.C., 5683 RIVERDALE AVENUE, SUITE 203 BOX 900, BRONX, NY, 10471-0900, US

(21) Appl. No.: 11/885,680

(22) PCT Filed: Nov. 17, 2005
(86) PCT No.: PCT/EP2005/012311

§ 371 Date: Sep. 4, 2007

(30) Foreign Application Priority Data
Mar. 1, 2005 (DE) 10 2005 009 193.8

(51) Int. Cl. H01H 9/00

(52) U.S. Cl. 200/336

(57) ABSTRACT

The invention relates to a tap-changer for low power switching on a step transformer. Said tap-changer is closed on the top by a tap-changer head which comprises a head flange wherein a drive shaft, which is guided from the outside, is mounted. An upper gear step and a hand wheel drive can be mounted on said head flange by means of a compatible hand wheel drive flange without requiring additional components, in particular, a special tap-changer head.

The invention relates to a tap changer for power-free switching over between different winding taps of a tapped transformer for voltage setting.

Such a tap changer is already known from the company publication of the applicant “Umsteller DEETAP® U, Betriebsanleitung BA 249/02de,” printing 0204/200. This known tap changer operates according to the principle of the rotary tap changer. It comprises an insulating material housing at which fixed contacts are arranged circularly in each of several horizontal planes. A rotatable insulated switching shaft is disposed in the interior of this insulating material housing and carries in each horizontal plane at least one switching contact by which electrical connection can be made to the corresponding fixed contacts in different ways depending on the respective basic circuit, for example as a star-point tap changer, simple center tap changer, double center tap changer, series-parallel tap changer or star-delta tap changer.

The adjusting of the tap changer from one operating setting to another, i.e. the switching over between different winding taps of the connected tapped transformer, is carried out by rotation of the insulated switching shaft when the transformer is switched off, i.e. in the current-free and voltage-free state. The rotation of the insulated switching shaft usually takes place on a stepped transmission, on which an electric motor drive or also a mechanical manual drive acts as shall be explained in more detail in the following.

The upper closure of the known tap changer forms the tap changer head with the attached upper transmission stage and the Geneva transmission, which is disposed thereunder, for drive of the insulated switching shaft. A shaft emanating from the respective motor drive or manual drive is connected with an outer shaft coupling at the upper transmission stage; the rotational movement of the shaft is transmitted to the upper transmission stage by way of a worm gear on a drive shaft which is vertically mounted in the tap changer head and which in turn has a Geneva crank at its lower end. The Geneva crank engages in a Geneva wheel, which is fixedly arranged on the insulated switching shaft at the upper end.

A tap changer switching, i.e. a rotation of the insulated switching shaft through a defined angle with respect to the respective adjacent fixed contact, thus corresponds with a defined number, which is dependent on type, of revolutions of the driving shaft of the motor drive or manual drive.

Certain variants of the known tap changer have instead, as a special construction, a direct mechanical actuation possibility of the insulated switching shaft by a handwheel, which is connected therewith and arranged centrally on the tap changer head, or a hexagon in conjunction with a socket wrench. Due to the direct central connection a special tap changer head is required for these constructions. This leads to an undesired variant multiplication of necessary pads of an otherwise identical tap changer.

It is accordingly the object of the invention to indicate a tap changer according to category which avoids these disadvantages and in which all described actuation possibilities of the insulated switching shaft can be realized by a single tap changer head.

This object is fulfilled by a tap changer with the features of the first patent claim. The subclaims relate to particularly advantageous developments of the invention.

The tap changer according to the invention has only a single tap changer head with a head flange, to which an upper gear stage for actuation by motor drive or manual drive or a handwheel drive flange for actuation by a handwheel or by means of a hexagon adapter can be selectably fastened. The drive shaft which, as described, carries the Geneva crank at its lower end is also identical for all forms of actuation.

The invention shall be explained in more detail in the following by way of examples of embodiment, wherein:

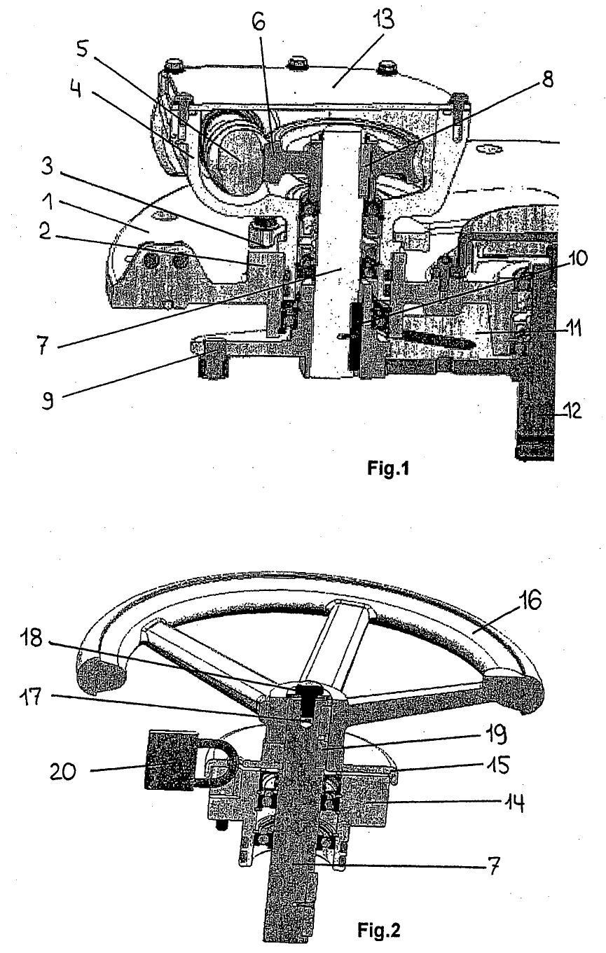

FIG. 1 shows a pad of the tap changer head of a tap changer according to the invention with an upper transmission stage mounted on the head flange,

FIG. 2 shows a handwheel drive with a handwheel drive flange which can be mounted instead of the upper transmission stage,

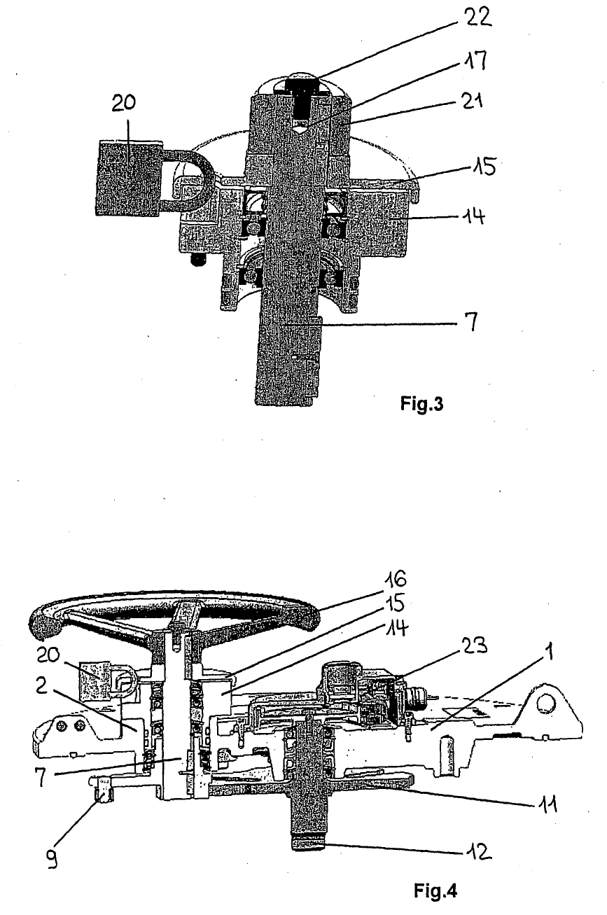

FIG. 3 shows a hexagon drive with, again, a handwheel drive flange which can be mounted instead of the upper transmission stage and

FIG. 4 shows a cross-section of the complete tap changer head of a tap changer according to the invention, here with mounted handwheel drive at the head flange.

Initially, FIG. 1 shall be explained. Here, a tap changer head 1 is shown which comprises a head flange 2 with several concentrically arranged threaded fastening bores 3. An upper transmission stage 4 is mounted on the head flange 2. This upper transmission stage 4 has, in a manner known per se, a worm wheel 5 disposed in connection with the shaft (not illustrated) emanating from the motor drive or manual drive. The worm wheel 5 acts on a gear wheel 6 fastened to the vertically extending drive shaft 7. The rotational securing is effected by a key-and-groove connection 8. The drive shaft 7 is mounted in the head flange 2. A Geneva crank 9 is fastened to the drive shaft 7 at the lower end; a further key-and-groove connection 10 serves for the rotational securing. The Geneva crank 9 acts on a Geneva wheel 11, which is fastened by its flange 12 to the upper part of the insulated switching shaft (not illustrated here). The upper transmission stage 4 is closed at the top by a cover 13. In the form of embodiment illustrated in this figure the drive of the tap changer thus takes place by way of a physically separately arranged motor drive or also a manual drive, wherein the rotational movement is transmitted by a corresponding shaft train to the worm wheel 5 of the upper transmission stage 4.

The components of an alternatively usable handwheel drive are shown in FIG. 2. Provided for this purpose is a handwheel drive flange 14 which is similarly fastenable to the head flange 2—not shown here—and in which the drive shaft 7 is mounted. The handwheel drive flange 14 has an upper cover 15 through which the drive shaft 7 is led. A handwheel 16 is fastened to the drive shaft 7 at the upper end. The fastening is effected by a thread 17 at the end face of the drive shaft 7 and the handwheel 16 is fastened by means of a screw 18; here, too, a key-and-groove connection 19, which corresponds in its physical position with the key-and-groove connection 8 in FIG. 1, is provided for the rotational securing. A safety lock 20 can be provided in order to prevent unauthorized adjustment.

An alternatively usable hexagon drive is shown in FIG. 3. It again has the handwheel drive flange 14 in which the drive shaft 7 is mounted. However, here instead of a handwheel a hexagon adapter 21 is fastened above the cover 15 again by means of a screw 22 in the thread 17 of the drive shaft 7.

The entire tap changer head of a tap changer according to the invention, here with mounted handwheel drive, is shown again in FIG. 4. it can be seen that the head flange 2 as also the entire tap changer head 1 are completely identical to the embodiment, which was explained in FIG. 1, with upper transmission stage. Instead of the upper transmission stage the handwheel drive flange 14 is here mounted on the head flange 2. The handwheel 16 acts on the drive shaft 7 and on the Geneva crank 9 arranged at the lower end and this in turn on the Geneva wheel 11 and thereby the insulated switching shaft. In this illustration for the sake of completeness an additionally arranged, known switch monitoring device 23 is also indicated, but is of no relevance to the invention and accordingly is not explained in more detail.

It can be seen that with the tap changer according to the invention, thus independently of whether the drive takes place by way of a motor drive or manual drive and a corresponding upper transmission stage or a handwheel drive or also a hexagon drive, the same transmission mechanism always carries out the rotational movement: from the drive shaft 7 by way of the Geneva crank 9 to the Geneva wheel 11 and from there to the insulated switching shaft. This has the consequence that for every form of actuation the same number of revolutions is required in order to execute an actuation of the tap changer. It can be seen that in the tap changer according to the invention the type multiplicity has been substantially reduced; the head flange 2 has the function of an adapter on which the upper transmission stage 4 or handwheel! drive flange 14 can be selectably mounted without further different components being required apart from the handwheel 16 and hexagon adapter 21 themselves.

1. A tap changer for power-free switching over between different winding taps of a tapped transformer for voltage setting, wherein fixed contacts are circularly arranged in at least one horizontal plane at an insulating material housing, wherein a rotatable insulated switching shaft is disposed in the interior and carries in each horizontal plane at least one switching contact by which electrical connection can be made with the corresponding fixed contacts, wherein the tap changer is closed at the top by a tap changer head having a Geneva transmission for drive of the insulated switching shaft, wherein the Geneva transmission, is itself drivable by a drive shaft which projects by its free end vertically upwardly out of the tap changer head and is mounted in a head flange which in turn has several threaded fastening bores, wherein an upper transmission stage which is known per se or a handwheel drive is selectably fastenable on the head flange at the threaded fastening bores, wherein the handwheel drive comprises a handwheel drive flange which can be screw-connected on the head flange, wherein the handwheel drive flange has an upper cover through which the drive shaft is led and wherein a handwheel or a hexagon adapter is fastened to the upper free end of the drive shaft.

2. The tap changer according to claim 1, wherein the handwheel or hexagon adapter is fastened by a screw screwed into a thread arranged at the drive shaft at the end face.

3. A tap changer comprising:
an insulating housing centered on a vertical axis;
a plurality of annular arrays of contacts fixed in the housing, the arrays lying in respective vertically spaced horizontally planes;
a vertical insulated switching shaft extending in the housing along the axis;
respective switching contacts carried on the shaft at each of the planes positioned to engage the fixed contacts of the respective array on rotation of the shaft;
a tap-changer head closing an upper end of the housing;
a head flange above the tap-changer head formed with threaded fastening bores;
a geneva transmission carried on the tap-changer head and having an output connected to the shaft and an input shaft projecting vertically upward from the head into the head flange;
an upper transmission stage boltable to the bores on the head flange and connectable to the input shaft; and
a handwheel drive having a flange with an upper cover through which the input shaft extends and a handwheel or hex fitting on an upper end of the input shaft.

4. The tap changer defined in claim 3 wherein the input shaft has at its upper end a screwthread and the handwheel or hex fitting includes a screws engaged with the screwthread.
